(19) United States
(12) Patent Application Publication
(10) Pub. No.: US 2005/0121600 A1
(43) Pub. Date: Jun. 9, 2005

(54) [ORGANIC ELECTROLUMINESCENT DEVICE AND FABRICATING METHOD THEREFOR]

(76) Inventors: TING-WEI CHUANG, TAINAN COUNTY (TW); JIUN-HAW LEE, TAIPEI (TW); CHIH-CHIEN LEE, TAOYUAN COUNTY (TW); PEIR-JY HU, HSINCHU CITY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,355

(22) Filed: Dec. 8, 2003

(51) Int. Cl. G01J 1/42

(52) U.S. Cl. 250/208.2

(57) ABSTRACT

An organic electroluminescent device and a method therefor are disclosed. The device comprises a transparent substrate and a plurality of pixels on the transparent substrate, wherein the pixels comprise red light pixels, green light pixels and blue light pixels. In addition, the device further comprises a red light detector adjacent to the red light pixels on the transparent substrate; a green light photo-detector adjacent to the green pixels on the transparent substrate and; and a blue light photo-detector adjacent to the blue pixels on the transparent substrate.

### BACKGROUND OF INVENTION

1. Field of the Invention

The present invention relates to an organic electroluminescent device and a fabricating method therefor, and more particularly to an organic electroluminescent device having photo-detectors and a fabricating method for integrating the organic electroluminescent device and photo-detectors.

2. Description of the Related Art

Computer, communication and consumer products have become the main trend of high technology. Portable electronic devices are also the essential products of development. Of course, displays are also included. Today, the displays include Plasma Display Panel (PDP), Liquid Crystal Display (LCD), Electro-luminescent Display, Light Emitting Diode Display, Vacuum Fluorescent Display, Field Emission Display (FED) and Electro-chromic Display.

Compared with these displays, the organic electroluminescent display, however, has advantages of self-luminescence, wide viewing angle, high resolution, low power consumption, easy manufacturing process, low costs, low operational temperature, fast response speed, low driving voltage, etc. It has potential application and can become the main trend for the next generation displays.

An organic electroluminescent device uses an organic electroluminescent material serving for display, which is composed of a pair of electrodes and an organic electroluminescent layer. When a current is applied to the device, electrons and holes recombine within the organic electroluminescent layer and generate photons. Therefore, light having different colors accordingly is generated depending on the material property of the organic electroluminescent layer.

However, a full-color organic electroluminescent display has different brightness degradation for red, green and blue light pixels. If the brightness degradation of different colors is not consistent, it will affect the performance of the display. Therefore, how to maintain the brightness stability of different colors of the full-color organic electroluminescent display is an essential issue that should be resolved.

### SUMMARY OF INVENTION

Therefore, the object of the present invention is to provide an organic electroluminescent device and a method therefore for resolving the issue of different degradations between red, green and blue pixels which create brightness unstability of the colors.

The present invention discloses an organic electroluminescent device, which comprises a transparent substrate, a plurality of pixels, a red-light detector, a green-light detector and a blue-light detector, wherein the pixels disposed on the transparent substrate comprise a plurality of red-light pixels, a plurality of green-light pixels and a plurality of blue-light pixels. Each of the pixels comprises, in sequence, a transparent anode, an organic electroluminescent layer and a metal cathode. The transparent anode is disposed on the transparent substrate. In addition, the red-light detector is disposed adjacent to the red-light pixels on the transparent substrate, the green-light detector is disposed adjacent to the green-light pixels on the transparent substrate and the blue-light detector is disposed adjacent to the blue-light pixels on the transparent substrate. Each of the red-light detector, the green-light detector and the blue-light detector comprises, in sequence, a metal anode, an electroluminescent layer and a metal cathode. The metal anode is disposed on the transparent substrate. The metal anode is a non-transparent metal layer and the electroluminescent layer is an organic material or an inorganic material. Moreover, the organic electroluminescent device of the present invention further comprises driving units coupled to each of the pixels, and each of the red-light detector, the green-light detector and the blue-light detector are coupled to transfer units. The driving units and the transfer units are coupled to a control unit. Therefore, when an organic electroluminescent layer of a pixel degrades, causing the reduction of brightness, the detector adjacent thereto detects the degradation.

Therefore, the transfer unit transmits the signal generated from the detector to the control unit. According to the degradation of the pixel, the control unit controls the driving unit increasing driving current to the pixel and maintaining the predetermined brightness of the pixel.

The present invention also discloses a method for fabricating an organic electroluminescent device. The method comprises: providing a transparent substrate; forming a plurality of pixels on the transparent substrate, wherein the pixels comprise a plurality of red-light pixels, a plurality of green-light pixels and a plurality of blue-light pixels; forming a red-light detector on the transparent substrate adjacent to the red-light pixels; forming a green-light detector on the transparent substrate adjacent to the green-light pixels; and forming a blue-light detector on the transparent substrate adjacent to the blue-light pixels. In the present invention, the step of forming the pixels, the red-light detector, the green-light detector and the blue-light detector comprises forming a patterned transparent anode and a patterned metal anode on the transparent substrate; forming an organic electroluminescent layer on the transparent anode and a electroluminescent layer on the metal anode; and forming a metal cathode on the organic electroluminescent layer and the electroluminescent layer for forming the pixels and the detectors. Moreover, the present invention further comprises coupling a driving unit to each of the pixels, and coupling each of the red-light detector, the green-light detector and the blue-light detector to transfer units.

Therefore, when an organic electroluminescent layer of a pixel degrades, causing the reduction of brightness, the detector adjacent thereto detects the degradation. In another word, the transfer unit transmits the signal generated from the detector to the control unit. According to the degradation of the pixel, the control unit controls the driving unit increasing driving current to the pixel and maintaining the predetermined brightness of the pixel.

The organic electroluminescent device and the method applied therefore can resolve the issues of different brightness degradation of pixels and brightness unstableness of colors by detecting the brightness of the pixels and controlling the current applied thereto.

In order to make the aforementioned and other objects, features and advantages of the present invention understandable, a preferred embodiment accompanied with figures is described in detail below.

### BRIEF DESCRIPTION OF DRAWINGS

FIG. 1 is a schematic structure showing a preferred embodiment of an organic electroluminescent device in accordance with the present invention.

### DETAILED DESCRIPTION

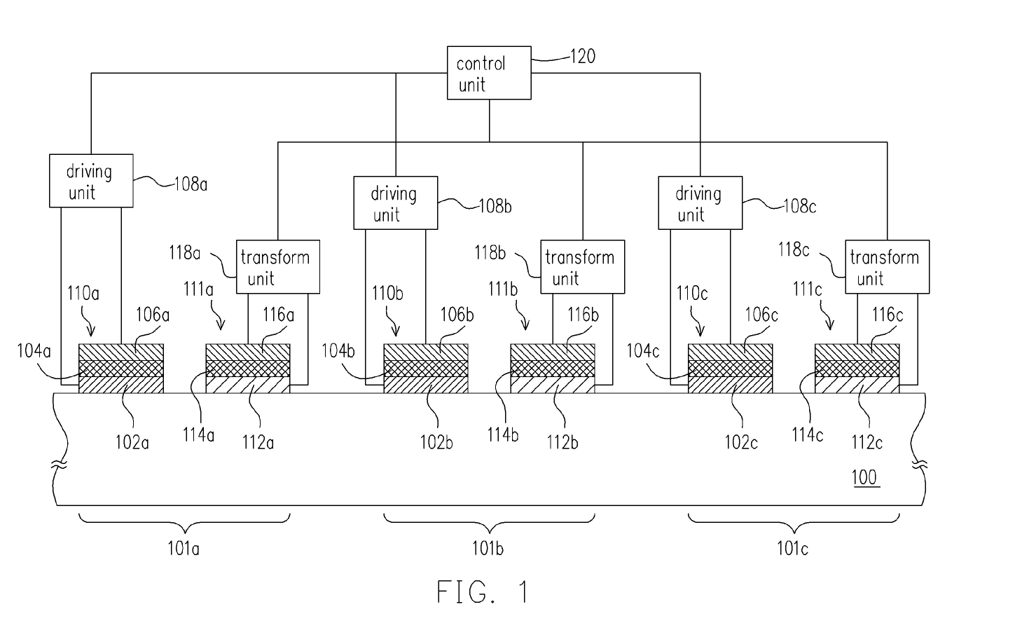

FIG. 1 is a schematic structure showing a preferred embodiment of an organic electroluminescent device in accordance with the present invention.

The pixels disposed on the transparent substrate comprise a red-light pixel, a green-light pixel and a blue-light pixel.Please referring to FIG. 1, the organic electroluminescent device of the present invention comprises a transparent substrate 100, a plurality of pixels 110a, 110b and 110c, a red-light detector 111a, a green-light detector 111b and a blue-light detector 111c.

The transparent substrate 100 has a red-light area 101a, a green-light area 101b and a blue-light area 101c. The pixels 110a, 110b and 110c disposed on the transparent substrate 100 comprise a red-light pixel 110a within the red-light area 101a, a green-light pixel 110b within the green-light area 101b and a blue-light pixel 110c within the blue-light area 101c. The pixels 110a, 110b and 110c comprise transparent anodes 102a, 102b and 102c disposed on the transparent substrate 100 respectively, organic electroluminescent layers 104a, 104b and 104c disposed on the transparent anodes 102a, 102b and 102c respectively and metal cathodes 106a, 106b and 106c disposed on the organic electroluminescent layers 104a, 104b and 104c respectively.

In addition, the red-light detector is disposed adjacent to the red-light pixels on the transparent substrate, the green-light detector is disposed adjacent to the green-light pixels on the transparent substrate and the blue-light detector is disposed adjacent to the blue-light pixels on the transparent substrate. The transparent anodes 102a, 102b and 102c comprise transparent material, such as indium-tin oxide or indium-zinc oxide. The metal cathodes 106a, 106b and 106c comprise, for example, aluminum, aluminum/lithium fluorine, calcium, magnesium/silver alloy or silver. The organic electroluminescent layer 104a, 104b and 104c comprise a hole injection layer (not shown), a hole transporting layer (not shown), a light-emitting layer (not shown), an electron transporting layer (not shown), and an electron injection layer (not shown). The organic electroluminescent layer 104a is, for example, a red-light small molecular organic electroluminescent material or a red-light polymer electroluminescent material. The organic electroluminescent 104b is, for example, a green-light small molecular organic electroluminescent material or a green-light polymer electroluminescent material. The organic electroluminescent 104c is, for example, a blue-light small molecular organic electroluminescent material or a blue-light polymer electroluminescent material.

The red-light detector 111a is adjacent to the red-light pixel 110a on the transparent substrate 100, i.e., within red-light area 101a. The green-light detector 111b is adjacent to the green-light pixel 110b on the transparent substrate 100, i.e., within the green-light area 101b. The blue-light detector 111c is adjacent to the blue-light pixel 110c on the transparent substrate 100, i.e., within the blue-light area 101c.

The red-light detector 111a, the green-light detector 111b and the blue-light detector 111c comprise metal anodes 112a, 112b and 112c disposed on the transparent substrate 100, electroluminescent layers 114a, 114b and 114c disposed on the metal anodes 112a, 112b and 112c respectively and metal cathodes 116a, 116b and 116c disposed on the organic electroluminescent layers 114a, 114b and 114c respectively. In the present invention, the metal anodes 112a, 112b and 112c are a non-transparent metal layer for preventing interference to the detectors 111a, 111b and 111c due to the light from the transparent substrate 100. The metal anodes 112a, 112b and 112c have the same or different material of the metal cathodes 116a, 116b and 116c. The electroluminescent layers 114a, 114b and 114c are an organic material or an inorganic material.

In the present invention, the method of forming the pixels 110a, 110b and 110c, the red-light detector 111a, the green-light detector 111b and the blue-light detector 111c comprises forming patterned transparent anodes 102a, 102b and 102c and patterned metal anodes 112a, 112b and 112c on the transparent substrate 100; forming organic electroluminescent layers 104a, 104b and 104c on the transparent anodes 102a, 102b and 102c respectively and electroluminescent layers 114a, 114b and 114c on the metal anodes 112a, 112b and 112c respectively; and forming metal cathodes 106a, 106b and 106c on the organic electroluminescent layers 104a, 104b and 104c respectively and metal cathodes 116a, 116b and 116c on the electroluminescent layer 114a, 114b and 114c respectively for forming the pixels 110a, 110b and 110c and the detectors 111a, 111b and 111c.

Because a portion of light generated from the organic electroluminescent device goes out of the device, a portion of light generates a wave-guide phenomenon within the transparent substrate 100 and another portion of light generates a wave-guide phenomenon between the transparent anodes 102a, 102b and 102c and the organic electroluminescent layers 104a, 104b and 104c. Therefore, a light guider (not shown) adjacent to the pixels 110a, 110b and 110c can induce the light within the device and transmits to the detectors 111a, 111b and 111c. When the energy of the light entering the detectors 111a, 111b and 111c is less than the band gap, no electron-hole will be generated. When the energy of the light entering the detectors 111a, 111b and 111c is larger than the band gap, electrons will be activated from valance band to conduction band and electron-hole is therefore generated. By the currents generated from the detectors 111a, 111b and 111c, the brightness of the pixels 110a, 110b and 110c can be detected.

Moreover, the pixels 110a, 110b and 110c of the organic electroluminescent device of the present invention further comprise driving units 108a, 108b and 108c coupled to the pixels 110a, 110b and 110c, and the red-light detector 111a, the green-light detector 111b and the blue-light detector 111c are coupled to transfer units 118a, 118b and 118c. The driving units 108a, 108b and 108c and the transfer units 118a, 118b and 118c are coupled to a control unit 120.

Therefore, when organic electroluminescent layers 104a, 104b and 104c of pixels 110a, 110b and 110c degrade, causing the reduction of brightness, the detectors 111a, 111b and 111c adjacent thereto detect the degradation. In another word, the transfer units 118a, 118b and 118c transmit the signals generated from the detector 111a, 111b and 111c to the control unit 120. According to the degradation of the pixels 110a, 110b and 110c, the control unit 120 controls the driving units 108a, 108b and 108c increasing driving current to the pixels 110a, 110b and 110c and maintaining the predetermined brightness of the pixels 110a, 110b and 110c.

Therefore, the organic electroluminescent device and the method applied therefore can resolve the issues of different brightness degradation of pixels and brightness unstableness of colors by detecting the brightness of the pixels and controlling the current applied thereto.

Moreover, the pixels of the organic electroluminescent device have the process and material similar to those of the detectors. It can simplify the manufacturing process and reduce costs thereof.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. An organic electroluminescent device, comprising:
a transparent substrate;
a plurality of pixels disposed on the transparent substrate, wherein the pixels comprise a plurality of red-light pixels, a plurality of green-light pixels and a plurality of blue-light pixels;
a red-light detector disposed adjacent to the red-light pixels on the transparent substrate;
a green-light detector disposed adjacent to the green-light pixels on the transparent substrate; and
a blue-light detector disposed adjacent to the blue-light pixels on the transparent substrate.

2. The organic electroluminescent device of claim 1, wherein each pixel comprises, in sequence, a transparent anode, an organic electroluminescent layer and a metal cathode.

3. The organic electroluminescent device of claim 2, wherein the transparent anode comprises indium-tin oxide or indium-zinc oxide.

4. The organic electroluminescent device of claim 2, wherein the organic electroluminescent layer is made of-small molecular organic electroluminescent material or polymer electroluminescent material.

5. The organic electroluminescent device of claim 2, wherein the metal cathode comprises aluminum, aluminum/lithium fluorine, calcium, magnesium/silver alloy or silver.

6. The organic electroluminescent device of claim 1, wherein each of the red-light detector, the green-light detector and the blue-light detector comprises, in sequence, a metal anode, a electroluminescent layer and a metal cathode.

7. The organic electroluminescent device of claim 6, wherein the metal anode comprises a non-transparent metal layer.

8. The organic electroluminescent device of claim 6, wherein the electroluminescent layer comprises an organic material or an inorganic material.

9. The organic electroluminescent device of claim 6, wherein the metal anode has the same or different material of the metal cathode.

10. The organic electroluminescent device of claim 1, further comprising a light guider coupled to each of the pixels transmitting the light within the device to the corresponding detector.

11. The organic electroluminescent device of claim 1, further comprising a driving unit coupled to each of the pixels, and each of the red-light detector, the green-light detector and the blue-light detector coupled to transfer units.

12. The organic electroluminescent device of claim 11, wherein the driving unit and the transfer units are coupled to a control unit.

13. A method for fabricating an organic electroluminescent device, comprising:
providing a transparent substrate;
forming a plurality of pixels on the transparent substrate, wherein the pixels comprise a plurality of red-light pixels, a plurality of green-light pixels and a plurality of blue-light pixels;
forming a red-light detector adjacent to the red-light pixels on the transparent substrate;
forming a green-light detector adjacent to the green-light pixels on the transparent substrate; and
forming a blue-light detector adjacent to the blue-light pixels on the transparent substrate.

14. The method for fabricating an organic electroluminescent device of claim 13, the step of forming the pixels, the red-light detector, the green-light detector and the blue-light detector comprises:
forming a patterned transparent anode and a patterned metal anode on the transparent substrate;
forming an organic electroluminescent layer on the transparent anode and a electroluminescent layer on the metal anode respectively; and
forming a metal cathode on the organic electroluminescent layer and the electroluminescent layer respectively.

15. The method for fabricating an organic electroluminescent device of claim 14, wherein the anode comprises indium-tin oxide or indium-zinc oxide.

16. The method for fabricating an organic electroluminescent device of claim 14, wherein the metal anode comprises a non-transparent metal layer.

17. The method for fabricating an organic electroluminescent device of claim 14, wherein the electroluminescent layer comprises an organic material or an inorganic material.

18. The method for fabricating an organic electroluminescent device of claim 14, wherein the organic electroluminescent layer is made of small molecular organic electroluminescent material or polymer electroluminescent material.

19. The method for fabricating an organic electroluminescent device of claim 14, wherein the metal anode has the same or different material of the metal cathode.

20. The method for fabricating an organic electroluminescent device of claim 14, wherein the metal cathode comprises aluminum, aluminum/lithium fluorine, calcium, magnesium/silver alloy or silver.
